(19) United States
(12) Patent Application Publication
(10) Pub. No.: US 2023/0337568 A1
(43) Pub. Date: Oct. 26, 2023

(54) SMART IMPLEMENTS

(71) Applicant: Agtonomy, South San Francisco, CA (US)

(72) Inventors: Timothy Bucher, Geyserville, CA (US); Steven Holmes, Redwood City, CA (US)

(21) Appl. No.: 18/315,085

(22) Filed: May 10, 2023

Related U.S. Application Data
(63) Continuation-in-part of application No. 17/647,731, filed on Jan. 11, 2022.
(60) Provisional application No. 63/364,541, filed on May 11, 2022.
(60) Provisional application No. 63/136,197, filed on Jan. 11, 2021.
(60) Provisional application No. 63/208,388, filed on Jun. 8, 2021.

(51) Int. Cl. A01B 79/00; A01B 76/00; A01D 69/02; A01B 59/06; A01D 34/00

(52) U.S. Cl. CPC A01B 79/005; A01B 76/00; A01D 69/02; A01B 59/06; A01D 34/008; A01D 69/002

(57) ABSTRACT

An agricultural implement may include an implement configured to perform an agricultural function and a connector configured to removably couple the implement to a vehicle. The agricultural implement may also include one or more computing devices coupled to the implement and configured to execute instructions to cause the implement system to perform operations. The operations may include automatically direct an adjustment to the performance of the agricultural function of the implement based on data about an electric motor of the vehicle.

### RELATED APPLICATIONS

The present application claims priority to U.S. Provisional Patent Application No. 63/364,541, filed on May 11, 2022 and is a Continuation-in-Part Application of U.S. Non-Provisional application Ser. No. 17/647,731, filed on Jan. 11, 2022, which claims priority to U.S. Provisional Patent Application No. 63/136,197, filed on Jan. 11, 2021, and U.S. Provisional Patent Application No. 63/208,388, filed on Jun. 8, 2021. The entire contents of each of which are incorporated by reference in the present disclosure.

### FIELD

The present disclosure is generally directed towards smart implements.

### BACKGROUND

Unless otherwise indicated herein, the materials described herein are not prior art to the claims in the present application and are not admitted to be prior art by inclusion in this section.

Farming and agricultural ventures are often associated with labor intensive work and long hours. In some circumstances, long hours may be attributed to the large tracts of land and numerous crops that may be included in an operation. In some instances, tractors and other large machinery are used in conjunction with attached implements to manage the tracts of land. Some implements may consume large amounts of energy and/or time.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In an embodiment, an agricultural implement may include an implement configured to perform an agricultural function and a connector configured to removably couple the implement to a vehicle. The agricultural implement may also include one or more computing devices coupled to the implement and configured to execute instructions to cause the implement system to perform operations. The operations may include automatically direct an adjustment to the performance of the agricultural function of the implement based on data about an electric motor of the vehicle.

These and other aspects, features and advantages may become more fully apparent from the following brief description of the drawings, the drawings, the detailed description, and appended claims.

### BRIEF DESCRIPTION OF THE DRAWINGS

Example embodiments will be described and explained with additional specificity and detail through the use of the accompanying drawings in which:

FIG. 1 illustrates a number of example smart implements;

FIG. 2 is a block diagram of an example smart implement control system;

FIG. 3 is a block diagram of an example system for controlling an implement;

FIG. 4 illustrates a block diagram of an example computing system; and

FIG. 5 illustrates an example flowchart of an example method of controlling an implement;

FIG. 6 illustrates an example environment that includes an agricultural implement;

FIG. 7 illustrates another example environment that includes an agricultural implement;

FIG. 8 illustrates another example environment that includes an agricultural implement;

FIG. 9 illustrates another example flowchart of an example method of agricultural implement control; and

FIG. 10 illustrates an example flowchart of an example method of agricultural implement control, all arranged in accordance with at least one embodiment of the present disclosure.

### DESCRIPTION OF EMBODIMENTS

Agricultural undertakings, including farming, are often time consuming and of a large scale such that power vehicles and equipment provide a great benefit in accomplishing tasks related thereto. Tractors and other agricultural equipment may be used to help reduce the amount of time required to cultivate land and/or crops. In some circumstances, various implements may be attached to the tractors and other agricultural equipment that may be used to help accomplish tasks.

Implements simplify much of the agricultural process but also use a large amount of energy to operate. As the energy is provided by an associated tractor or other vehicle, use of implements may contribute to increased amounts of pollution and/or energy consumption of the tractor. Further, once connected and in operation, implements are often designed to run at or near 100% capacity until disconnected.

In some embodiments, a smart implement may include variable power consumption, as determined by the implement, or as directed by the associated tractor. In some circumstances, the smart implement may detect the surrounding environment or information related to the current task which may be used to direct the amount of power consumption by the smart implement.

In some embodiments of the present disclosure, a smart implement may reduce the amount of power requested from an associated tractor, such that the tractor may be more energy efficient. Further, the smart implement may improve the speed of which tasks are completed by increasing power consumption to complete the tasks as circumstances permit or dictate.

In the present disclosure, the term “tractor” may refer to an agricultural tractor and/or other power equipment or vehicles that may be used in an agricultural setting. Alternatively or additionally, the term “tractor” may include a power vehicle that may be configured to support and operate an implement, which may be used in the agricultural setting or any other applicable setting. Further, while discussed in primarily an agricultural setting, some embodiments of the present disclosure may be used in other settings, such as mining, construction, and/or other locales where large machinery may be beneficial.

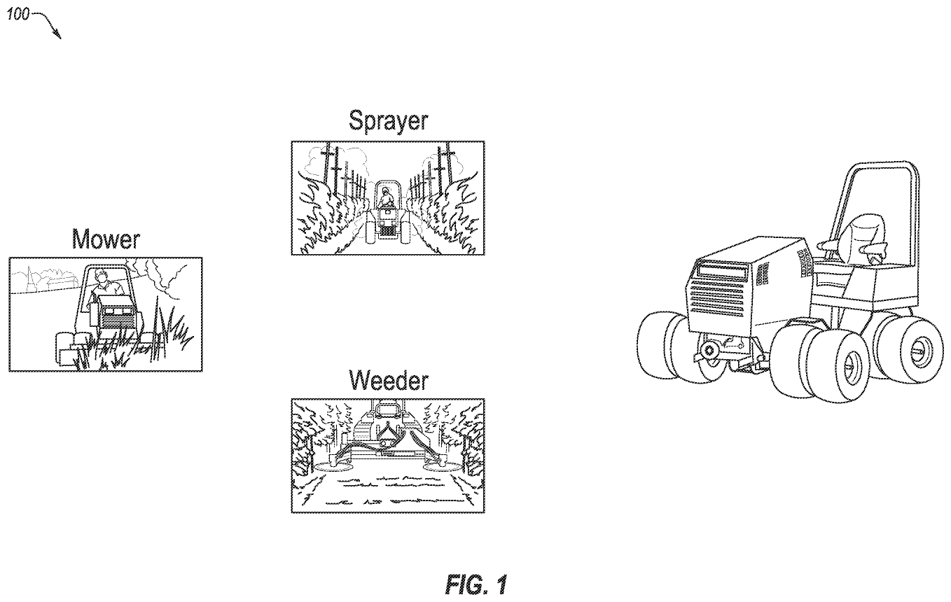

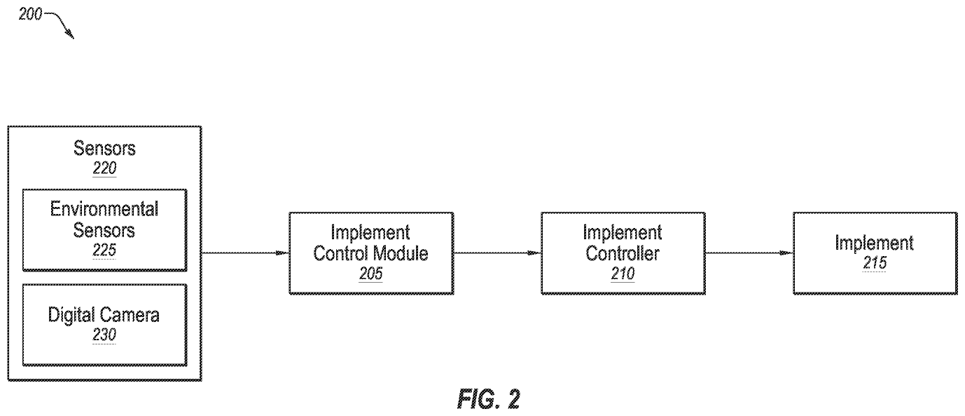

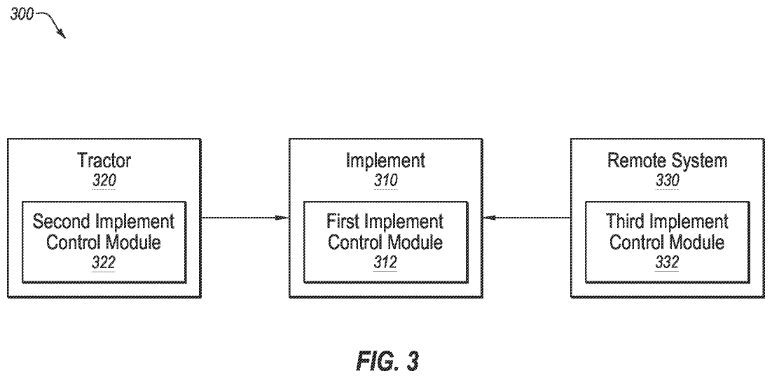

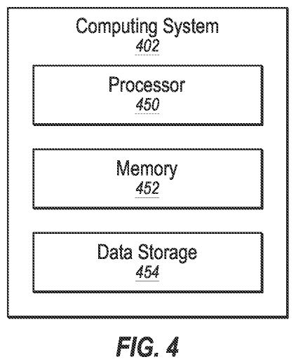

FIG. 1 illustrates a number of example smart implements 100, in accordance with at least one embodiment described in the present disclosure. The example smart implements 100 may include some or all of the components as discussed in conjunction with FIG. 2, FIG. 3, and/or FIG. 4. For example, the smart implement may include a mower, sprayer, weeder, and/or harvester, such as an implement that picks fruit, grain, vegetables, or other items.

FIG. 2 is a block diagram of an example smart implement control system 200 of a smart implement 100 of FIG. 1, in accordance with at least one embodiment described in the present disclosure. The smart implement control system 200 may include an implement control module 205, implement controller 210, and one or more sensors 220. The one or more sensors 220 may include environmental sensors 225 and a digital camera 230.

The implement control module 205 may include code and routines configured to enable a computing system to perform one or more operations. Additionally or alternatively, the implement control module 205 may be implemented using hardware including a processor, a microprocessor (e.g., to perform or control performance of one or more operations), a field-programmable gate array (FPGA), or an application-specific integrated circuit (ASIC). In some other instances, the implement control module 205 may be implemented using a combination of hardware and software. In the present disclosure, operations described as being performed by the implement control module 205 may include operations that the implement control module 205 may direct a corresponding system to perform. Further, although described separately in the present disclosure to ease explanation of different operations performed and roles, in some embodiments, one or more portions of the implement control module 205 may be combined or part of the same module.

In some embodiments, the implement control module 205 may be configured to interface with the implement 215, such as by the implement controller 210, where the implement 215 may be attached to and/or be powered by a tractor analogously to methods in which other implements attach to and/or are powered by the tractor. For example, the implement 215 may be configured to attach to the tractor via power takeoff (PTO). Alternatively or additionally, the interface between the implement 215 and the tractor may include an electrical connection, and/or any other processes configured to variably transfer power from the tractor to the implement 215. In some embodiments, the implement control module 205 may be configured to determine a varying power request for the implement 215 and may interface with the tractor such that the tractor may provide a variable power delivery. In some embodiments, the implement controller 210 may be configured to provide the controls to the implement 215. The variable power delivery from the implement controller 210 may be in the alternative to and/or in addition to the implement 215 receiving a constant power delivery from the tractor. For example, the amount of power output of the implement 215 may vary based on the amount of power as determined by the implement control module 205 and requested by the implement controller 210, which may be delivered by the tractor.

In some embodiments, the implement controller 210 may be configured to interface with the implement control module 205 and/or the implement 215. For example, the implement controller 210 may be configured to receive input from the implement control module 205 that may be used by the implement controller 210 to cause movement and/or operations of the implement 215. In some embodiments, the implement controller 210 may include one or more motors, actuators, and/or other mechanical devices configured to cause the implement 215 to move. For example, in instances in which the implement control module 205 determines that a sprayer implement may be more effective spraying crops at a further distance from the crops, the implement controller 210 may receive commands from the implement control module 205 and may cause the sprayer implement to retract from the crops and continue to apply a spray.

In some embodiments, the implement control module 205 may provide an output to the implement controller 210 such that the implement 215 may be idled and/or powered down when not in use, including instances in which the implement 215 is connected to a currently operating tractor via PTO. For example, the implement control module 205 may determine to the implement 215 in instances in which the implement 215 may not be used, such as when the tractor makes turns at the end of a row, or transfers from a first location to a second location to continue operations. In some embodiments, the implement control module 205 may receive sensor input from the one or more sensors 220, which may contribute to determining instances in which the implement 215 may be powered down. For example, the digital camera 230 may be configured to detect the tractor is not adjacent to any crops and the implement control module 205 may determine that the implement 215 may be powered down. Alternatively or additionally, the environmental sensors 225 may detect that an amount of work the implement 215 is configured to perform (e.g., mowing weeds) has decreased below a threshold for using the implement 215 and the implement control module 205 may determine that the implement 215 may be powered down. Alternatively or additionally, the tractor may provide an input to the implement control module 205 that the current tractor speed is greater than a threshold for using the implement 215 and the implement control module 205 may determine that the implement 215 may be powered down.

In some embodiments, the implement control module 205 may be configured to receive input from the one or more sensors 220 that may be used to determine a power draw requested by the implement controller 210 and/or the implement 215. For example, the one or more sensors 220 may provide an indication to the implement control module 205 of an amount of force being exerted by the implement 215. For example, in instances in which a mower is the implement 215, the implement control module 205 may determine the mower may benefit from more delivered power based on received input from the one or more sensors 220, which may indicate, based on the amount of force being exerted by the mower, that the mower is currently mowing dense and/or wet grass.

In some embodiments, the implement control module 205 may be configured to vary the speed of the tractor based on the determined power draw of the implement control module 205. For example, in instances in which a mower is the implement 215 and the mower is currently mowing dense and/or wet grass, the implement control module 205 may provide feedback to the tractor to decrease the tractor speed which may improve the mowing results by the mower. Alternatively or additionally, in instances in which a mower is the implement 215 and the mower is currently mowing light and/or dry grass, the implement control module 205 may provide feedback to the tractor to increase the tractor speed, up to a threshold, which may improve the mowing results by the mower.

In these and other embodiments, the implement control module 205 may be configured to use the requested power draw of the implement controller 210 and/or the implement 215 to manage the power usage of the tractor and/or the implement 215 and/or the speed of the tractor and/or the implement 215. Alternatively or additionally, the implement control module 205 may store the requested power draw over time and may use the stored requested power draw to determine instances in which service to the implement 215 and/or the tractor may contribute to extending the life thereof.

In some embodiments, the implement control module 205 may determine that the implement 215 may be idled and/or powered down may reduce the power consumption of the tractor, which may contribute to a reduced resource drain of the tractor. For example, in instances in which the tractor is an electric vehicle, powering down the implement 215 may result in less drain of the batteries, which may enable the electric tractor to be used for longer periods of time between charges.

In some embodiments, the one or more sensors 220 may be configured to provide sensor input to the implement control module 205 which may be used to direct the tractor to vary the amount of power delivered to the implement 215. In some embodiments, the implement control module 205 may request a variation of power from the tractor based on input and/or data received from the one or more sensors 220. For example, in instances in which the one or more sensors 220 detect an increased workload, the implement control module 205 may request more power from the tractor.

In some embodiments, the implement control module 205 may receive sensor input from the one or more sensors 220. In some embodiments, the one or more sensors 220 may be disposed on the implement 215 and may be configured to detect the operating environment of the implement 215. For example, the one or more sensors 220 that may be coupled to the implement 215 may include a digital camera 230, infrared sensors, radar sensors, lidar sensors, moisture sensors, and/or other environmental sensors 225 which may be disposed on an interior and/or exterior surface of the implement 215. Alternatively or additionally, the one or more sensors 220 may be disposed on the tractor and may be configured to provide sensor input to the implement control module 205. For example, the one or more sensors 220 may be coupled with and/or integrate with the tractor and may capture and send sensor data to the implement control module 205 that may be used to direct operation of the implement 215. Alternatively or additionally, the one or more sensors 220 may be disposed at locations remote from the tractor and/or the implement 215, where the remote sensor input may be communicated to the implement control module 205. For example, the one or more sensors 220 may be disposed throughout the area in which the tractor and/or implement 215 are operating and the remote sensor input may capture and send sensor data to the implement control module 205 that may be used to direct operation of the implement 215.

In instances in which the one or more sensors 220 are disposed on a smart mower, the one or more sensors 220 may detect a density of grass (i.e., plants and/or other objects to be mowed), an amount of binding of cut grass within the implement 215, a moisture level of the grass, and/or other mowing factors. In instances in which the one or more sensors 220 are disposed on a smart sprayer, the one or more sensors 220 may detect a range to the target, an environmental wind speed and direction, a humidity, and/or other spray factors.

In some embodiments, the implement control module 205 may be configured to be in communication with the tractor to which the implement 215 is attached. For example, the implement control module 205 may provide an indication to the tractor of the current workload and/or updates regarding the perceived operating environment of the implement 215. In some embodiments, the implement control module 205 may include software and/or hardware components capable of implementing artificial intelligence (AI) and/or machine learning. Alternatively or additionally, the implement control module 205 may transmit sensor data from the one or more sensors 220 to the tractor and/or a remote system which tractor and/or remote system may include the software and/or hardware components capable of implementing artificial intelligence and/or machine learning.

In some embodiments, the AI and/or machine learning system may be integrated with the implement control module 205, such that the implement control module 205 may perform some or all of the functions of the AI and/or machine learning system. Alternatively or additionally, the AI and/or machine learning may be separate and/or distinct from the implement control module 205 and may be configured to communicate with the implement control module 205. For example, in instances in which the AI and/or machine learning is separate from the implement control module 205, the operation of the AI and/or machine learning system may be performed by a computing system, such as the computing system 402 of FIG. 4.

In some embodiments, the implement control module 205 may aggregate data from the one or more sensors 220 to improve the response time of the operation of the implement 215 to the detected environment and/or predict a response based on the detected environment. For example, the implement control module 205 may use positional data and/or sensor data from the one or more sensors 220 to determine that a section of a tract of land grows grass at a faster rate and may request the tractor increase power delivered to the implement 215, such as a mower, when the tractor enters the section. Alternatively or additionally, the implement control module 205 may use time data and/or sensor data to determine that mowing at certain times of the day may result in wetter grass (e.g., mowing in the morning with dew present), and may send a request to the tractor to increase power to the implement 215 at early times and/or reduce power as the day advances.

In some embodiments, the implement control module 205 may be configured to measure and record a run time and/or an operational time of the implement 215. For example, the implement control module 205 may record an amount of time the implement 215 is powered on (i.e., the run time) and/or an amount of time the implement 215 is performing a task (i.e., the operational time). Alternatively or additionally, the implement control module 205 may be configured to determine an intensity level of the conditions the implement 215 is operating under, such as based on data from the one or more sensors 220. For example, in instance in which a mower is the implement 215, sensor data obtained by the implement control module 205 may indicate a height, a density, a moisture level, and/or other characteristics of grass to be mowed, such that the implement control module 205 may determine an intensity level related to the operation of the implement 215. In some embodiments, the intensity level may include a metric that may be calculated by the implement control module 205, such as a weighted score and/or combination of various metrics related to the intensity of operation of the implement 215.

In these and other embodiments, the implement control module 205 may be configured to use the data associated with the run time, the operational time, and/or the intensity level of the conditions, to determine a maintenance schedule for the implement 215. For example, the implement control module 205 may determine a usage metric by summing a run time metric, an operational time metric, and an intensity level metric and compare it to a threshold. When the usage metric exceeds the threshold, the implement control module 205 may determine the implement 215 may be benefitted from maintenance. In some embodiments, the implement control module 205 may be configured to provide the maintenance data to an operator of the implement. For example, in instances in which the implement control module 205 has determined the usage metric exceeds the threshold, the implement control module 205 may be configured to provide a visual indication, an aural indication, a tactile indication, and/or may provide a transmitted message to the operator, such as described below.

In some embodiments, the implement control module 205 may be configured to wirelessly communicate with other devices. For example, the implement control module 205 may be configured to communicate via wireless channels including Wi-Fi, WiMAX, Bluetooth®, cellular communications, and/or other wireless technologies. In some embodiments, the implement control module 205 may wirelessly communicate with the tractor and/or an operator's mobile device. A mobile device may include a mobile phone, tablet, personal computer, and/or other mobile devices. In some embodiments, the wireless communication from the implement control module 205 to a mobile device may be via mobile application that may include a graphical user interface for displaying received data (e.g. sensor data) and transmitted control data (e.g., control instructions in the implement controller 210) related to the implement control module 205, and/or operational information of the implement 215. In some embodiments, the implement control module 205 may wirelessly transmit sensor data and/or operational data to the mobile device. For example, the implement control module 205 may transmit a current RPM, a recommended implement RPM, a percentage representing the current RPM as a percentage of maximum RPM, a recommended tractor speed, a recommended time until next implement service, total operational hours, and/or other operational data of the implement 215.

In some embodiments, the implement control module 205 may be configured to receive wireless communications from the mobile device which may be used with the implement control module 205 to provide controls to the implement controller 210 that may control the implement 215. For example, the mobile device may transmit a maximum RPM, a recommended tractor speed, and/or other commands to the implement control module 205. Alternatively or additionally, the mobile device may transmit wireless communications to the tractor, which may, in turn, interface with the implement control module 205. In these and other embodiments, the operator may input commands into the mobile application which may wirelessly transfer the data to either directly to the implement control module 205 and/or indirectly to the implement control module 205, such as via the tractor.

In some embodiments, the tractor may respond to received data from the implement control module 205 which may improve efficiency and/or operations. For example, in response to receiving data from the implement control module 205 that the implement 215 is underused, the tractor may increase the tractor speed and/or decrease the power delivered to the implement 215.

In some embodiments, the implement control module 205 may be used in conjunction with existing implements that may not include one or more sensors, but that may be outfitted with the one or more sensors 220 as described above. For example, the implement control module 205 may be used in conjunction with a mower, a weeder, a sprayer, a seeder, and/or other similar attachable implements for use with tractors. Alternatively or additionally, the implement control module 205 may be integrated with implements 215 that include the one or more sensors 220. For example, an implement such as a smart mower may include the one or more sensors 220 which may include the environmental sensors 225 and/or the digital camera 230 that may provide sensor data to the implement control module 205.

In some embodiments, the implement control module 205 may receive a default tractor speed for operation based on the implement 215 in use, which speed may be transmitted to the tractor. For example, the implement control module 205 may determine a smart mower's default speed be slower than a smart sprayer's default speed. Alternatively or additionally, the default speed, as determined by the implement control module 205, may be set and/or adjusted based on data received by the implement control module 205 from previous operations. For example, in instances in which the one or more sensors 220 associated with a smart mower repeatedly provides data to the implement control module 205 that slows down the tractor, the implement control module 205 may determine that the default speed for the smart mower may be reduced.

In some embodiments, the implement control module 205 may be implemented with an existing agricultural vehicle, such as a tractor, which may be outfitted to include additional sensors and/or hardware to communicate with the implement control module 205. Alternatively or additionally, the implement control module 205 may be integrated with a future agricultural vehicle, such as an autonomous land drone as described in U.S. Provisional Patent Application Ser. No. 63/136,197.

FIG. 3 is a block diagram of an example system 300 for controlling an implement, in accordance with at least one embodiment described in the present disclosure. The system 300 may include an implement 310, a tractor 320, and a remote system 330. The implement 310 may include a first implement control module 312, the tractor 320 may include a second implement control module 322, and the remote system 330 may include a third implement control module 332.

In some embodiments, the first implement control module 312 may be disposed on or in the implement 310, the second implement control module 322 may be disposed on or in the tractor 320, and the third implement control module 332 may be disposed on or in the remote system 330. The implement 310 may be analogous to the implement 215 of FIG. 2.

In some embodiments, the first implement control module 312 may be configured to direct operation of the implement 310. For example, the first implement control module 312 may receive sensor input and/or may determine operational control of the implement 310. Alternatively or additionally, the first implement control module 312, the second implement control module 322, and the third implement control module 332 may be configured to interface with each other to direct operation of the implement 310. For example, receiving sensor input, analyzing the sensor data and tractor operations, and providing the control operations for the implement 310 may be distributed and performed by combinations of the three implement control modules. Alternatively or additionally, one of the first implement control module 312, the second implement control module 322, and the third implement control module 332 may perform some or all the operations for operating the implement 310. For example, in some embodiments, only the second implement control module 322 or the third implement control module 332 may be present to direct operation of the implement 310. Alternatively or additionally, other various combinations of the three implement control modules may be used to direct operation of the implement 310.

FIG. 4 illustrates a block diagram of an example computing system 402, according to at least one embodiment of the present disclosure. The computing system 402 may be configured to implement or direct one or more operations associated with an implement control module (e.g., the implement control module 205 of FIG. 2). The computing system 402 may include a processor 450, a memory 452, and a data storage 454. The processor 450, the memory 452, and the data storage 454 may be communicatively coupled.

In general, the processor 450 may include any suitable special-purpose or general-purpose computer, computing entity, or processing device including various computer hardware or software modules and may be configured to execute instructions stored on any applicable computer-readable storage media. For example, the processor 450 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, the processor 450 may include any number of processors configured to, individually or collectively, perform or direct performance of any number of operations described in the present disclosure. Additionally, one or more of the processors may be present on one or more different electronic devices, such as different servers.

In some embodiments, the processor 450 may be configured to interpret and/or execute program instructions and/or process data stored in the memory 452, the data storage 454, or the memory 452 and the data storage 454. In some embodiments, the processor 450 may fetch program instructions from the data storage 454 and load the program instructions in the memory 452. After the program instructions are loaded into memory 452, the processor 450 may execute the program instructions.

For example, in some embodiments, an implement control module may be included in the data storage 454 as program instructions. The processor 450 may fetch the program instructions of a corresponding module from the data storage 454 and may load the program instructions of the corresponding module in the memory 452. After the program instructions of the corresponding module are loaded into memory 452, the processor 450 may execute the program instructions such that the computing system may implement the operations associated with the corresponding module as directed by the instructions.

The memory 452 and the data storage 454 may include computer-readable storage media for carrying or having computer-executable instructions or data structures stored thereon. Such computer-readable storage media may include any available media that may be accessed by a general-purpose or special-purpose computer, such as the processor 450. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 450 to perform a certain operation or group of operations.

Modifications, additions, or omissions may be made to the computing system 402 without departing from the scope of the present disclosure. For example, in some embodiments, the computing system 402 may include any number of other components that may not be explicitly illustrated or described.

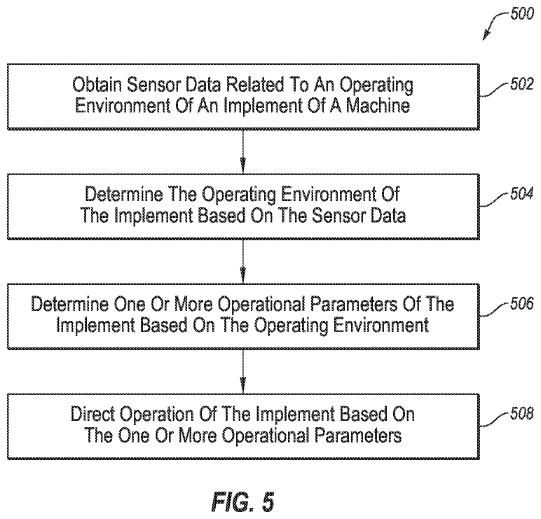

FIG. 5 illustrates an example flowchart of an example method 500 of controlling an implement, described according to at least one embodiment of the present disclosure. The method 500 may be performed by any suitable system, apparatus, or device. For example, one or more of the operations of the method 500 may be performed by an implement control module, an implement controller, and/or a computing system, such as those described above. Further, the implement 215 or the implement 310 described above may be examples of the implement that may be controlled.

At block 502, sensor data may be obtained. For example, in some embodiments, sensor data such as that described above with respect to the sensors 220 of FIG. 2 may be obtained.

At block 504, an operating environment of an implement may be determined. In some embodiments, conditions about the environment such as those described above with respect to FIG. 2 may be determined based on the sensor data and may be examples of the different operating environments that may be encountered by the implement.

At block 506, one or more operational parameters of the implement may be determined. The operational parameters may include any parameters that may affect operation of the implement, such as amount of power to provide to the implement, when to engage the implement (e.g., power up), when to disengage the implement (e.g., power down), adjustment of speed of a tractor or other machine using the implement, etc. In some embodiments, the examples of such parameters given with respect to FIG. 2 may be example operational parameters.

At block 508, operation of the implement may be directed based on the determined operational parameters. For example, the tractor or other machine may be directed to provide a certain amount of power to the implement, operate at a certain speed, etc., according to the determined operational parameters.

Modifications, additions, or omissions may be made to the method 500 without departing from the scope of the present disclosure. For example, the order of one or more of the operations described may vary than the order in which they were described or are illustrated. Further, each operation may include more or fewer operations than those described. For example, any number of the operations and concepts described above with respect to FIG. 2 may be included in or incorporated by the method 500. In addition, the delineation of the operations and elements is meant for explanatory purposes and is not meant to be limiting with respect to actual implementations.

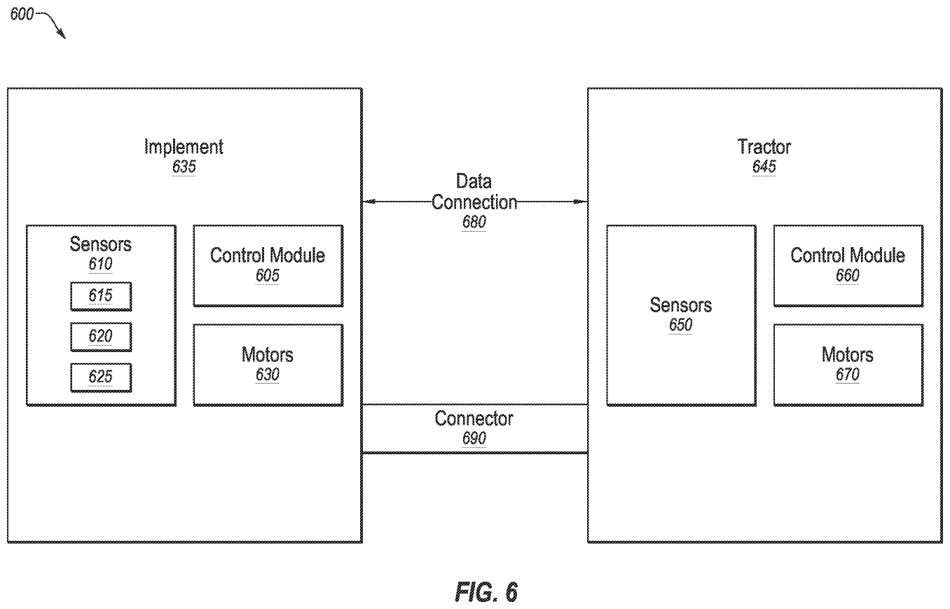

FIG. 6 illustrates an example environment 600 that includes an implement, in accordance with at least one embodiment described in the present disclosure. The environment 600 may include an implement 635 and a tractor 645. The implement 635 may include sensors 610, that may include environmental sensors 615, operational sensors 620, and positional sensors 625. The implement 635 may also include an implement control module 605 and one or more motors 630. The tractor 645 may include sensors 650 that may be configured similar to the sensors 610 of the implement 635. The tractor 645 may further include a tractor control module 660 and one or more motors 670.

In some embodiments, the tractor 645 and the implement 635 may be mechanically coupled via a connector 690. For example, the implement 635 may be carried by or supported by the tractor 645. For example, the implement 635 may be one of the implements as described in FIGS. 1 and 2. In some embodiments, the implement 635 may be configured to be couple to and/or be powered by the tractor 645 analogously to methods in which other implements are coupled to and/or are powered by a tractor. For example, the implement 635 may be configured to couple to the tractor 645 via a power takeoff (PTO).

In these and other embodiments, the connector 690 may also mechanically or electrically couple the implement 635 and the tractor 645. For example, the connector 690 may include an electrical connection, and/or any other processes configured to variably transfer power from the tractor 645 to the implement 635. In some embodiments, the implement 635 may be configured to receive a variable power delivery from the tractor 645. The variable power delivery from the tractor 645 may be in the alternative and/or in addition to the implement 635 receiving a constant power delivery from the tractor 645.

In some embodiments, a data connection 680 may exist between the tractor 645 and the implement 635. Data may be shared between the implement 635 and the tractor 645 over the data connection. The data may include information from the sensors 610, the sensor 650, the implement control module 605, and the tractor control module 660. In these and other embodiments, the data may be shared via one or more application programming interfaces (APIs). For example, each of the implement control module 605 and the tractor control module 660 may include one or more APIs for the sharing of data between the implement 635 and the tractor 645.

In some embodiments, some elements of the implement 635 may be located on the tractor 645. For example, the implement control module 605 and/or the sensors 610 may be located on the tractor 645. In these and other embodiments, the implement 635 may include a data storage and a processor that may include instructions to operate the implement control module 605. In these and other embodiments, instructions to execute the implement control module 605 may be run by a processor of the tractor 645 and interface directly with the tractor control module 660 over a communication bus in the tractor 645 instead of over the data connection 680. Alternately or additionally, the implement 635 may not include the motors 630. In these and other embodiments, the implement 635 may be powered directly by the tractor 645.

Alternatively or additionally, one or more elements of the implement 635 may be located remote from the implement 635 and the tractor 645. For example, one or more of the sensors 610 may be located remote from the implement 635 and the tractor 645, such as in a field among crops in which the tractor 645 is configured to operate. Alternatively or additionally, one or more portions of the implement control module 605 may be located remote from the tractor 645 such that one or more of data storage and/or processing related to the implement control module 605 may be conducted over a network, for example as explained with respect to FIG. 3.

In some embodiments, the sensors 610 may be configured to communicate with the implement control module 605. For example, the environmental sensors 615, the operational sensors 620, and/or the positional sensors 625 may be configured to transmit acquired data to the implement control module 605 for additional processing. In some embodiments, the sensors 610 may be used to detect the environment, the operation of the implement 635, and/or the associated location data of the motors 630, the implement 635, the attachments 640, and/or the tractor 645. In some embodiments, the data obtained by the implement control module 605 from the sensors 610 may be stored and/or subsequently retrieved by the implement control module 605 for future reference. For example, in instances in which the implement control module 605 directs the implement 635 to sample a leaf from a crop, mow a patch of grass, pick a crop, or perform other agricultural operations, the implement control module 605 may store the environmental, operational, and/or positional data associated with the operation.

Alternatively or additionally, the implement control module 605 may be configured to communicate with and/or obtain data from other devices and sensors associated with the tractor 645 to which the implement 635 is coupled. For example, the implement control module 605 may obtain and use data generated by a crop view system. In some embodiments, the operation of the implement control module 605 may be performed by a computing system, such as the computing system 402 of FIG. 4.

The implement control module 605 may include code and routines configured to enable a computing system to perform one or more operations. Additionally or alternatively, the implement control module 605 may be implemented using hardware including a processor, a microprocessor (e.g., to perform or control performance of one or more operations), a field-programmable gate array (FPGA), or an application-specific integrated circuit (ASIC). In some other instances, the implement control module 605 may be implemented using a combination of hardware and software. In the present disclosure, operations described as being performed by the implement control module 605 may include operations that the implement control module 605 may direct a corresponding system to perform. Further, although described separately in the present disclosure to ease explanation of different operations performed and roles, in some embodiments, one or more portions of the implement control module 605 may be combined or part of the same module.

In some embodiments, the environment 600 may include the environmental sensors 615 that may be configured to detect environmental conditions. The environmental sensors 615 may include one or more of digital cameras, infrared sensors, radar sensors, lidar sensors, moisture sensors, weather sensors, soil sensors, and/or other environmental sensors. The weather sensors may be configured to measure one or more of temperature, barometric pressure, precipitation, humidity, solar radiation, wind speed, wind direction, lightning strike count, and/or lightning strike distance. In some embodiments, the environmental sensors 615 may generate environmental data related to the environment associated with the implement 635 and/or the tractor 645. In some embodiments, the implement control module 605 may be configured to obtain the environmental data from the environmental sensors 615.

In some embodiments, the environment 600 may include the operational sensors 620 that may be configured to detect the operation of the motors 630, the implement 635, the attachments 640, and/or the tractor 645. In some embodiments, the operational sensors 620 may include the same or similar sensors as the environmental sensors 615. For example, the operational sensors 620 may include digital cameras, infrared sensors, radar sensors, and/or lidar sensors. In some embodiments, the implement control module 605 may be configured to obtain the operational data from the operational sensors 620.

In some embodiments, the operational sensors 620 may be configured to sense the operation of elements in the environment 600, such as the operation of the motors 630 and the implement 635. For example, the operational sensors 620 may be configured to sense an RPM, a torque, various applied forces, etc., associated with the implement 635. In some embodiments, the operational data from the operational sensors 620 may vary based on the implement 635. For example, the operational data associated with a sprayer may include an amount of spray delivered per minute while operational data associated with a picker may include a force applied to harvest fruit.

Alternatively or additionally, the operational sensors 620 may be configured to sense information associated with the motors 630. The motors 630 may be associated with the tractor 645 or the implement 635. For example, one or more of the motors 630 may be associated with the implement 635 and be configured to control the implement 635. Alternately or additionally, one or more of the motors 630 may be associated with the tractor 645. For example, one or more of the motors 630 may be associated with a drive train of the tractor 645 such that the one or more of the motors 630 may drive one or more wheels of the tractor 645. Alternately or additionally, the one or more of the motors 630 may be associated with the tractor 645 may drive, e.g. supply torque or power, to the implement 635.

In these and other embodiments, one or more of the motors 630 may be an electric motor. In these and other embodiments, the operational sensors 620 may be one or more electric motor controllers configured to control the one or more of the motors 630. The electric motor controllers may include multiple different types of data regarding the one or more of the motors 630 that may be updated at particular intervals. For example, the different types of data may include a torque value, a rotational position, a rotational speed, current usage, power usage, and/or voltage usage among other data types of an electric motor. In these and other embodiments, the torque value may include an amount of torque, i.e. rotational force, being applied by a shaft of the electric motor. The rotational position may include a current position of a shaft through a rotational path. For example, the rotational position may be ¼ of a distance through the rotational path. The rotational speed may include an RPM of the electric motor. The current, power, and/or voltage may indicate the current electrical requirements of the electric motor.

In some embodiments, the implement control module 605 may be configured to use the environmental data from the environmental sensors 615 to detect various crop statuses. For example, based on environmental data from the environmental sensors 615, the implement control module 605 may detect bugs and/or other pests located on and/or around the crops. Alternatively or additionally, the implement control module 605 may use the operational data from the operational sensors 620 combined with environmental data from the environmental sensors 615 to detect a status of the environment that may affect the operation of the implement 635. For example, in instances in which the implement 635 is configured to spray crops, the implement control module 605 may use weather sensors of the environmental sensors 615 to determine a wind speed and/or wind direction. The implement control module 605 may direct the motors 630 to control the operation of the implement 635 to deliver a spray to a crop in view of the current weather conditions, which may reduce the overall amount spray used and may reduce the amount of excess spray not reaching the intended crop.

In some embodiments, the implement control module 605 may obtain positional data from the positional sensors 625, which may be configured to determine positional data associated with the implement 635 and/or the tractor 645. In some embodiments, the positional sensors 625 may include one or more of a GPS, one or more accelerometers, and/or one or more gyroscopes.

In some embodiments, the positional data from the positional sensors 625 may include coarse positional data associated with a crop upon which the implement 635 is working. For example, the implement control module 605 may associate the coarse positional data from the positional sensors 625 with a sampled leaf from a crop by the implement 635, such that the implement control module 605 may identify the crop from which the sampled leaf was obtained.

Alternatively or additionally, the positional sensors 625 may generate fine positional data associated with the position of the implement 635 during operation. For example, the implement control module 605 may associate the fine positional data from the positional sensors 625 with a sampled leaf from a crop by the implement 635, such that the implement control module 605 may identify the branch and the branch location on the crop from which the sampled leaf was obtained.

Alternately or additionally, the implement control module 605 may use a combination of the positional data and the operational data to determine a position of the implement 635 and/or the tractor 645. For example, the implement control module 605 may determine a current position of the tractor 645 based on data from the motors 670 that drive the wheels of the tractor 645. For example, the implement control module 605 may obtain the rotational position and/or the rotational speed of the motors 670. Using the rotational position and/or the rotational speed along with the size of the wheels, an amount of time, and a previous position, the implement control module 605 may determine a current position of the tractor 645. In these and other embodiments, the implement control module 605 may check the current position, calculated with the data from the motors 670, using the positional data from the positional sensors 625.

As another example, the implement control module 605 may determine a location, angle, distance from, or some other aspects of the implement 635 with respect to the tractor 645 based on a rotational position of an electric motor that controls the movement and placement of the implement 635. As another example, the implement control module 605 may determine a height, angle, distance from, or some other aspects of the implement 635 with respect to the a crop based on a rotational position of an electric motor that controls the movement and placement of the implement 635. For example, the implement 635 may be configured to move in three or moves axis, such as up to six axis. In these and other embodiments, a motor may control the movement of the implement 635. The position of the implement 635 in three-dimensional space may be determined based on the data from the electric motor. The position of the implement 635 may be verified using one of the other sensors 610.

Alternately or additionally, the implement control module 605 may request data from the tractor 645 regarding the position of the implement 635 and/or the position of the tractor 645. In these and other embodiments, the tractor control module 660 may be configured to use data from the sensors 650 and/or the sensors 610 to determine the position of the tractor 645 and may provide the data to the control module 605. Alternately or additionally, the tractor control module 660 may determine the position of the implement 635 in a similar manner and provide the information to the implement 635 per a request from the implement 635.

In these and other embodiments, the implement control module 605 may be configured to obtain environmental data, operational data, and/or positional data from the environmental sensors 615, the operational sensors 620, and/or the positional sensors 625, respectively, and make determinations regarding the use of the implement 635. For example, the implement control module 605 may determine from the environmental data that bugs are present on a crop. The implement control module 605 may further determine to apply a spray to the affected crop using operational and positional data from the operational sensors 620 and the positional sensors 625, respectively, in view of the environmental data from the environmental sensors 615 (e.g., such as a current wind speed and wind direction).

In some embodiments, the environment 600 may include the motors 630 that may be configured to receive input from the implement control module 605. The motors 630 may be used to conduct movement of the implement 635, such as to position the implement 635 to perform a task. For example, the implement control module 605 may direct the motors 630 to move the implement 635 in up to six axes to perform a task, such as sampling a leaf from a desired crop.

In some embodiments, the sensors 650 of the tractor 645 may be similar to the sensors 610 of the implement 635. Alternately or additionally, the tractor 645 may not include the sensors 650. In these and other embodiments, the tractor 645 may obtain data from the sensors 610. Alternately or additionally, the tractor 645 may obtain from the sensors 610 when the tractor 645 includes the sensors 650. In these and other embodiments, the data from the sensors 610 may be shared with the tractor 645 and the data from the sensors 650 may be shared with the implement 635.

During operation of the implement 635 and the tractor 645, the tractor 645 may be configured to perform navigation and the implement 635 may be configured to perform an agricultural function. The tractor 645 may be navigated to allow the performance of the agricultural function. In these and other embodiments, the tractor 645 may be navigated by a human user, semi autonomously, or fully autonomously. During semi-autonomous navigation, a user may direct the location of the tractor 645 for some aspects, but the tractor control module 660 may control the speed and/or finer navigational aspects when performing the agricultural function of the implement 635.

Performance of the agricultural function may be dependent on the navigation of the tractor 645. For example, navigation of the tractor 645 too fast may result in degradation of the agricultural function. Thus, the implement 635 may be configured to provide information to the tractor 645 to adjust the navigation of the tractor 645. Furthermore, information known by the tractor 645 may assist in the performance of the agricultural function by the implement 635. For example, the position of the tractor 645 or the position of the implement 635 as controlled by the tractor may help in the performance of the agricultural function. Thus, sharing of information between the tractor 645 and the implement 635 may be result in better performance of the agricultural function. In these and other embodiments, the tractor 645 and/or the implement 635 may thus direct the other of the devices to improve performance of the agricultural function.

During the operation, the implement 635 may obtain information from the tractor 645. Based on the information from the tractor 645, the implement 635 may adjust the agricultural function. For example, the implement 635 may obtain data about an electric motor of the vehicle. The data about the electric motor as previously described may indicate a position of the tractor 645, a position of the implement 635, a force being provided the implement 635, such as an RPM of an axel driving the implement 635, and/or a speed of the tractor 645. In these and other embodiments, the implement 635 may adjust the agricultural function based on the data about the electric motor. In these and other embodiments, the tractor 645 may provide the data about the electric motor directly to the implement 635. Alternately or additionally, the tractor 645 may provide data derived using the data about the electric motor to the implement 635. In these and other embodiments, the implement 635 may adjust the performance of the agricultural function based on the data from the tractor 645. As an example, based on the speed of the tractor 645, the implement 635 may adjust a flow volume of a sprayer. Other examples are provided with respect to FIG. 2 and further description regarding the interaction between the tractor 645 and the implement 635 is provided with respect to FIG. 2.

In some embodiments, the implement 635 may be configured to direct data to the tractor 645. In these and other embodiments, the tractor 645 may adjust an operation of the tractor 645 based on the data from the implement 635. For example, the implement 635 may provide information to the tractor 645 to adjust the positioning of the tractor 645, a speed of the tractor 645, and an amount of power delivered to the implement by the tractor 645. For example, the implement 635 may generate data based on the performance of the agricultural function. Based on the performance of the agricultural function, the implement 635 may direct the tractor 645 to adjust the operation of the tractor 645. In these and other embodiments, the implement 635 may provide data to the tractor 645 that the tractor 645 may use to determine the adjustment in the operation of the tractor 645. Alternately or additionally, the implement 635 may provide the commands or directive of the adjustment in the operation of the tractor 645. In these and other embodiments, the data obtained by the implement 635 may be obtained from one or more of the sensors 610 and/or one or more of the sensors 650. The data provided to the tractor 645 may come from any of the sensors 610 of the implement 635. As an example, based on the flow volume of a sprayer, the implement control module 605 may provide data to the tractor control module 660 to adjust a speed of the tractor 645. Other examples are provided with respect to FIG. 2 and further description regarding the interaction between the tractor 645 and the implement 635 is provided with respect to FIG. 2.

In some embodiments, the implement 635 may be coupled to the tractor 645. In response to coupling with the tractor 645, the implement 635 may obtain the capabilities of the tractor 645. For example, the capabilities of the tractor 645 may include the type of data the tractor 645 may provide the implement 635, the type of adjustments that tractor 645 may autonomously or semi-autonomously make or suggest to an operator of the tractor 645. In these and other embodiments, the implement 635 may adjust the operation of the agriculture function based on the capabilities of the tractor 645. For example, based on the capabilities of the tractor to only provide an approximate speed and no speed adjustment, the implement 635 may run a first algorithm to perform the agriculture function in place of a second algorithm that may be provide directions and/or data to the tractor 645 for adjustments to the operations of the tractor 645. In these and other embodiments, the implement 635 may adapt to the capabilities of the tractor 645 when performing the agricultural function.

Alternately or additionally, the tractor 645 in a similar manner may obtain the capabilities of the implement 635 to determine the type of data to provide to the implement 635 and/or to adjust the operation of the tractor 645 based on the capabilities of the implement 635 attached thereto. In these and other embodiments, the tractor 645 may provide the data based on requests from the implement 635. For example, the tractor 645 may have a multiple APIs that may provide information that the tractor 645 may make available to any implement 635. As such, the implement 635 may use one or more of APIs of the tractor 645 according to the functionality of the implement 635 and not all of the APIs. Alternately or additionally, the implement 635 may have multiple APIs as well. In these and other embodiments, the tractor 645 may use one or more of the APIs of the implement 635 according to the functionality of the tractor 645 and not all of the APIs. In this manner, a tractor and an implement with different levels of autonomous functionality may be used together.

Modifications, additions, or omissions may be made to the environment 600 without departing from the scope of the present disclosure. For example, in some embodiments, the environment 600 may include any number of other components that may not be explicitly illustrated or described.

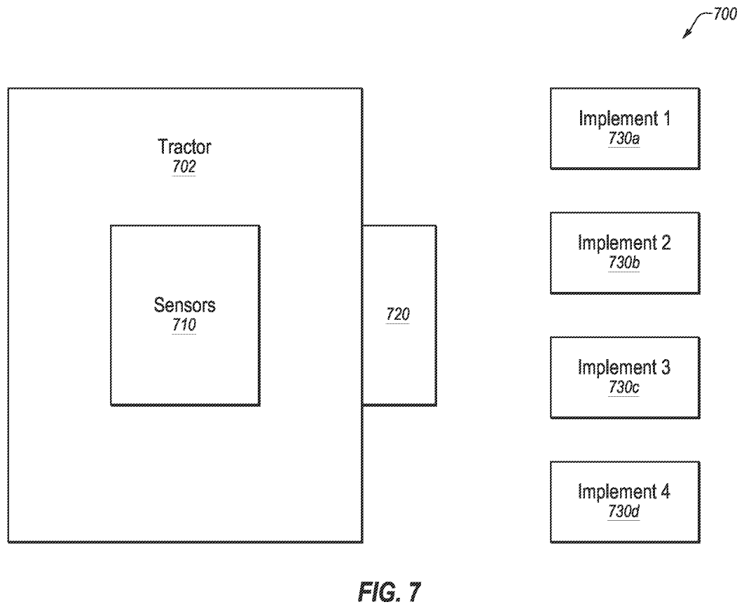

FIG. 7 illustrates an example environment 700 that includes an implement, in accordance with at least one embodiment described in the present disclosure. The environment 700 may include a tractor 702 that includes one or more sensors 710 and a connector 720. The environment may also include a first implement 730a, a second implement 703b, a third implement 730c, and a fourth implement 730d, referred to collectively as the implements 730.

The tractor 702 and the sensors 710 may be example of tractors and sensor discussed previously in this disclosure. Furthermore, the implements 730 may be examples of implements discussed previously in this disclosure.

The tractor 702 may be configured to obtain an instruction to perform an agricultural function. For example, the tractor 702 may be configured to mow vegetation, pick a crop, or spray a crop. The tractor 702 may select an implement of multiple types of implements to use based on the agricultural function. Alternately or additionally, the tractor 702 may be directed to the type of implement to use. The tractor 702 may move to a position to couple the selected implement to the tractor 702. At the position, there may be more than one implement. For example, as illustrated in FIG. 7, there may be four implements 730. The tractor 702 may be configured to determine the selected implement from among the implements 730. For example, the tractor 702 may obtain data from the sensors 710 to determine the implement. The data may include image data of the implements 730. In some embodiments, the tractor 702 may be configured to recognize an image of the implement to select among from the images of the implements 730. Alternately or additionally, the tractor 702 may send out an energy pulse, such as radio frequency identification technology, corresponding to the selected implement to determine which of the implements to select. In these and other embodiments, the tractor 702 may couple the selected implement to the tractor 702 via the connector 720.

In some embodiments, while performing the agricultural function of the selected implement, an additional agricultural function may be identified. The additional agricultural function may be identified by the tractor 702 and/or the selected implement. For example, based on data from the sensors 710, the tractor 702 may determine the additional agricultural function to perform. As an example, while spraying crops, the tractor 702 may sense the height of vegetation in a section of land that may be above threshold height for mowing. As such, the tractor 702 may determine to the mow the vegetation of the section. The tractor 702 may determine the additional implement to use to perform the additional agricultural function. In these and other embodiments, after or before finishing the agricultural function of the selected implement, the tractor 702 may autonomously disconnect the currently coupled implement. The tractor 702 may further identify the additional implement. For example, the tractor 702 may identify the additional implement using image data. The tractor 702 may be configured to couple the additional implement to the connector 720 and take actions to perform the additional agricultural function.

Modifications, additions, or omissions may be made to the environment 700 without departing from the scope of the present disclosure. For example, in some embodiments, environment 700 may include any number of other components that may not be explicitly illustrated or described.

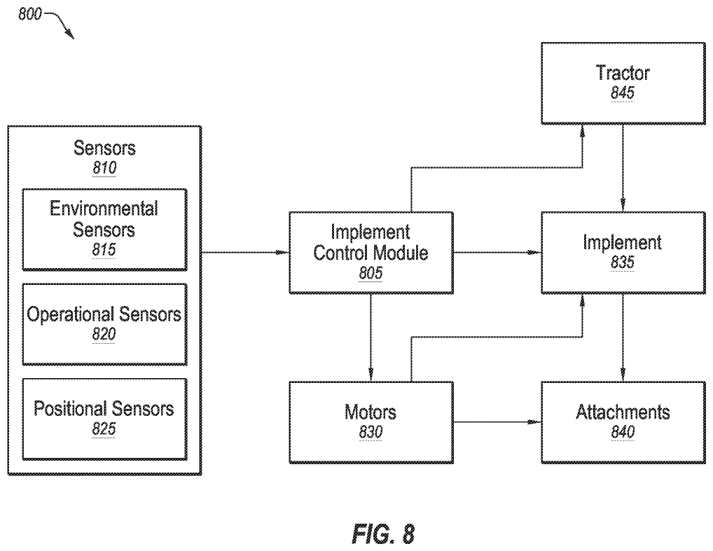

FIG. 8 illustrates an example environment 800 that includes an implement 835, in accordance with at least one embodiment described in the present disclosure. The environment 800 may further include a tractor 845. The implement 835 may include sensors 810, that may include environmental sensors 815, operational sensors 820, and positional sensors 825. The implement 835 may also include an. The environment 800 may further include an implement control module 805, a motor 830, and attachments 840.

In these and other embodiments, the elements of the environment 800 may be analogous to the elements described in this disclosure. The attachments 840 may be agricultural attachments that may perform different agricultural functions. The attachments 840 may be configured to be coupled to the implement 835 to function. For example, each of the attachments 840 may be coupled to the implement 835 individually. The implement 835 may provide power to and control of the attachments 840 and perform an agricultural function using the attachments 840.

In some embodiments, two of more of the attachments 840 may be carried by the tractor 845 along with the implement 835. In these and other embodiments, the implement 835 may be configured to couple to one of the attachments 840 and use the one of the attachments 840 to perform an agricultural function. After using the one of the attachments 840, the implement 835 may couple to another one of the attachments 840 and use the other one of the attachments 840 to perform another agricultural function.

In some embodiments, the motors 830 may be configured to provide movement to and/or operation of the attachments 840 that may be used in conjunction with the implement 835. For example, the implement 835 may include a vacuum attachment of the attachments 840 that may be powered by the motors 830. In another example, the implement 835 may include a grabber attachment of the attachments 840 that may be powered by the motors 830, such as positioning the grabbing attachment and/or opening and closing the grabbing portion thereof. In these and other embodiments, the motors 830 may cause movement and/or operation of the attachments 840 in response to receiving direction from the implement control module 805.

In some embodiments, a single motor 830 may be configured to maneuver the implement 835 in the at least six axes and control the attachments 840 associated with the implement 835. Alternatively or additionally, multiple motors 830 may be used to operate the movement of the implement 835 and/or the attachments 840 associated with the implement 835. Alternatively or additionally, a motor of the motors 830 may be associated with each moveable portion of the implement 835. For example, each axis of movement of the implement 835 may include a motor of the motors 830 configured to operate the implement 835 in the axis of movement. Further, each attachment of the attachments 840 associated with the implement 835 may include a motor of the motors 830.

In some embodiments, the attachments 840 may be configured to perform various tasks associated with the implement 835. In some embodiments, the attachments 840 may include one or more of a vacuum, a picker, a grabber, a cutter, a sprayer, and/or other attachments that may be used in conjunction with the implement 835. In some embodiments, the attachments 840 may be configured to perform different tasks in furtherance of crop maintenance and crop health. For example, the vacuum may be used to collect bugs located on various portions of the crops to determine pest type and likelihood of a pest infestation. Alternatively or additionally, the cutter may be used to prune a crop and/or trim a branch that may have a disease.

In some embodiments, the attachments 840 may be disposed on the tractor 845 and may be within reach of the implement 835. For example, the attachments 840 may include a unique location disposed on the tractor 845 such that the implement 835 may be able to reach the attachments 840. In some embodiments, the implement control module 805 may be configured to direct the implement 835 to switch between the attachments 840 autonomously. For example, in instances in which the implement control module 805 has determined the implement 835 is going to pick fruit but does not have a picker attachment connected to the implement 835, the implement control module 805 may direct the implement 835 to store the non-picker attachment. After storing the non-picker attachment, the implement control module 805 may direct the implement 835 to attach the fruit picker attachment of the attachments 840 and pick fruit from the crops. Alternatively or additionally, a user may manually reconfigure the attachments 840 to the implement 835 as desired, after which the implement control module 805 may direct operations of the implement 835 as previously described.

In some embodiments, the implement control module 805 may be configured to control operations of the motors 830, the implement 835, and/or the tractor 845. In some embodiments, the implement control module 805 may receive operator input as part of determining tasks to perform. For example, operator input may direct the implement control module 805 to sample a leaf from a crop. Further, operator input may direct the implement control module 805 to perform the leaf sampling once per week. Alternatively or additionally, the implement control module 805 may determine a task to perform based on input from the sensors 810. For example, in instances in which the environmental sensors 815 detect bugs present on the crops, the implement control module 805 may determine to vacuum the bugs and may direct the implement 835 to use the vacuum attachment to gather the bugs. In another example, in instances in which the implement control module 805 detects a potential disease in the crop from environmental data from the environmental sensors 815, the implement control module 805 may determine to sample a leaf and/or branch from the crop where the disease is observed. Further, the implement control module 805 may provide instructions to the implement 835 to use the attachments 840, such as the grabber and/or cutter attachments, to sample the leaves and/or branches of the crop. In some embodiments, the operation of the implement control module 805 may be performed by a computing system, such as the computing system 402 of FIG. 4.

In some embodiments, the implement control module 805 may be configured to associate the positional data from the positional sensors 825 with the task operations performed by the implement 835. For example, in instances in which the implement control module 805 determines a leaf to be sampled from a crop, the implement control module 805 may associate the positional data related to the crop with the sampled leaf such that a farmer may be able to locate the crop of the sampled leaf. Alternatively or additionally, the implement control module 805 may be configured to store the association between positional data and the performance of task operations. In some embodiments, the implement control module 805 may store both the coarse positional data and the fine positional data of the positional sensors 825 such that the farmer may be capable of locating the crop of the sample as well as the portion of the crop from where the sample was taken.

In some embodiments, the implement control module 805 may be configured to communicate with the tractor 845 on which it may be disposed, and/or in instances in which the implement control module 805 may be remote from the tractor 845 and configured to remotely communicate with the tractor 845. For example, in instances in which the implement control module 805 is disposed on an autonomous tractor and the autonomous tractor is performing a leaf sampling task, the implement control module 805 may communicate to the autonomous tractor that a leaf sample from the crop has been collected and that the autonomous tractor may move to the next crop for additional leaf samples. Alternatively or additionally, the implement control module 805 may be configured to provide an alert after a task has been completed. For example, in instances in which an operator is operating the tractor 845, the implement control module 805 may provide an audible notification that the implement 835 has finished gathering a leaf sample and is ready to move to another crop.

In some embodiments, the implement control module 805 may be configured to make follow-on determinations relative to a task performed. For example, in instances in which the implement control module 805 has directed the sampling of a leaf of a crop, the implement control module 805 may perform an analysis on the leaf, such as by one or more of the sensors 810, and may determine that the crop may have a disease. Alternatively or additionally, the implement control module 805 may be configured to carry out tasks associated with the follow-on determinations. For example, in instances in which the implement control module 805 has sampled a leaf, performed an analysis, and determined the crop has a disease, the implement control module 805 may be configured to direct the implement 835 to change attachments 840 to a sprayer and the implement control module 805 may direct the application of a spray to attempt to resist the disease.

Modifications, additions, or omissions may be made to the environment 800 without departing from the scope of the present disclosure. For example, in some embodiments, the environment 800 may include any number of other components that may not be explicitly illustrated or described.

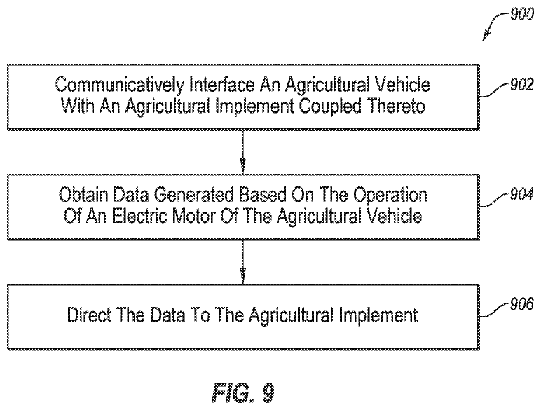

FIG. 9 illustrates an example flowchart of an example method 900 of controlling an implement, described according to at least one embodiment of the present disclosure. The method 900 may be performed by any suitable system, apparatus, or device. For example, one or more of the operations of the method 900 may be performed by an implement control module and/or a computing system, such as those described above. Further, the implement 215, the implement 310, the implement 635, 730, and 835 described above may be examples of the implement that may be controlled.

At block 902, communicatively interfacing an agricultural vehicle with an agricultural implement coupled thereto.

At block 904, obtaining data generated based on the operation of an electric motor of the agricultural vehicle. In some embodiments, the data may be generated based on the operation of the electric motor includes one or more of: a torque, a rotational position, a rotational speed, a current, power, and a voltage. Alternately or additionally, the electric motor may be configured to drive the implement or to drive at least one wheel of the vehicle. At block 906, directing the data to the agricultural implement.

Modifications, additions, or omissions may be made to the method 900 without departing from the scope of the present disclosure. For example, the order of one or more of the operations described may vary than the order in which they were described or are illustrated. Further, each operation may include more or fewer operations than those described. In addition, the delineation of the operations and elements is meant for explanatory purposes and is not meant to be limiting with respect to actual implementations.

For example, the method 900 may further include obtaining a request from the agricultural implement for the data. In these and other embodiments, the data may be directed to the agricultural implement in response to the request. Alternately or additionally, the method 900 may further include obtain second data from the coupled agricultural implement. The second data may be based on the performance of the agricultural function performed by the coupled agricultural implement. The method 900 may further include adjust an operation of the vehicle based on the second data.

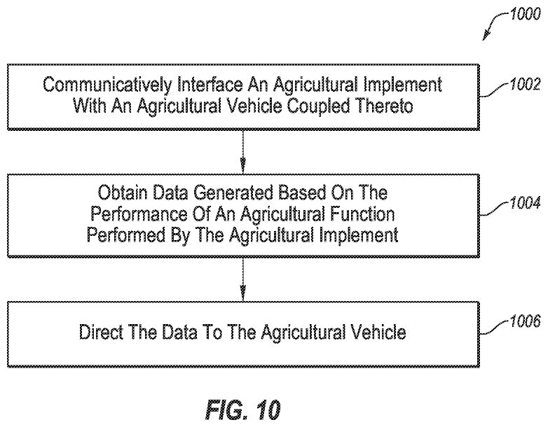

FIG. 10 illustrates an example flowchart of an example method 1000 of controlling an implement, described according to at least one embodiment of the present disclosure. The method 1000 may be performed by any suitable system, apparatus, or device. For example, one or more of the operations of the method 1000 may be performed by an implement control module and/or a computing system, such as those described above. Further, the implement 215, the implement 310, the implement 635, 730, and 835 described above may be examples of the implement that may be controlled.

At block 1002, communicatively interfacing an agricultural implement with an agricultural vehicle coupled thereto. At block 1004, obtaining data generated based on the performance of an agricultural function performed by the agricultural implement. At block 1006, directing the data to the agricultural vehicle.

Modifications, additions, or omissions may be made to the method 1000 without departing from the scope of the present disclosure. For example, the order of one or more of the operations described may vary than the order in which they were described or are illustrated. Further, each operation may include more or fewer operations than those described. In addition, the delineation of the operations and elements is meant for explanatory purposes and is not meant to be limiting with respect to actual implementations.

Alternately or additionally, the method 1000 may further include obtaining data about an electric motor of the agricultural vehicle and direct an adjustment to the performance of the agricultural function of the agricultural implement based on data.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” This interpretation of the phrase “A or B” is still applicable even though the term “A and/or B” may be used at times to include the possibilities of “A” or “B” or “A and B.” All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure. Accordingly, the scope of the invention is intended to be defined only by the claims which follow.

What is claimed is:

1. An agricultural implement, comprising:
an implement configured to perform an agricultural function;
a connector configured to removably couple the implement to a vehicle; and
one or more computing devices coupled to the implement and configured to execute instructions to cause the implement to perform operations, the operations comprising:
automatically direct an adjustment to the performance of the agricultural function of the implement based on data about an electric motor of the vehicle.

2. The agricultural implement of claim 1, wherein the data from the electric motor controller includes one or more of: a torque, a rotational position, rotational speed, current, power, and a voltage.

3. The agricultural implement of claim 1, wherein the operations further comprise:
generate second data based on the performance of the implement; and
direct the second data to the vehicle, the vehicle configured to automatically adjust an operation of the vehicle based on the second data.

4. The agricultural implement of claim 3, wherein the operation of the vehicle includes one or more of: positioning of the vehicle, a speed of the vehicle, and an amount of power delivered to the implement.

5. The agricultural implement of claim 3, further comprising a sensor configured to monitor the performance of the agricultural function by the implement.

6. The agricultural implement of claim 5, wherein the second data is generated by the sensor.

7. An agricultural vehicle comprising:
an electric motor, wherein data is generated based on an operation of the electric motor; and
one or more computing devices configured to execute instructions to cause the vehicle to perform operations, the operations comprising:
direct the data to an agricultural implement coupled to the vehicle, the data resulting in the coupled agricultural implement adjusting a performance of an agricultural function performed by the coupled agricultural implement.

8. The agricultural vehicle of claim 7, wherein the data generated based on the operation of the electric motor includes one or more of: a torque, a rotational position, a rotational speed, a current, power, and a voltage.

9. The agricultural vehicle of claim 7, further comprising a second electric motor that drives a wheel of the vehicle, wherein second data is generated based on the operation of the second electric motor and the electric motor is configured to drive the implement, wherein the operations further comprise:
direct the second data to an agricultural implement coupled to the vehicle, wherein the second data and the data results in the coupled agricultural implement adjusting the performance of the agricultural function performed by the coupled agricultural implement.

10. The agricultural vehicle of claim 7, further comprising an imaging sensor configured to generate image data, wherein the operations further comprise:
obtain an instruction to perform a particular agricultural function;
identify an agricultural implement to perform the particular agricultural function using the image data; and
direct coupling of the identified agricultural implement to the vehicle such that the identified agricultural implement is the coupled agricultural implement.

11. The agricultural vehicle of claim 10, wherein the operations further comprise:
in response to second data, select another agricultural function to be performed;
determine a second agricultural implement configured to perform the second agricultural function;
autonomously disconnect the coupled agricultural implement;
identify the second agricultural implement using the image data; and
direct coupling of the second agricultural implement to the vehicle.

12. The agricultural vehicle of claim 11, wherein the second data is generated by the implement.

13. The agricultural vehicle of claim 11, further comprising one or more sensors that are configured to generate the second data.

14. The agricultural vehicle of claim 7, wherein the operations further comprise:
obtain second data from the coupled agricultural implement, the second data based on the performance of the agricultural function performed by the coupled agricultural implement; and
adjust an operation of the vehicle based on the second data.

15. The agricultural vehicle of claim 14, further comprising one or more sensors configured to generate second data regarding an environment surrounding the vehicle, wherein the operations further comprise direct the second data to the agricultural implement coupled to the vehicle.

16. One or more computer-readable mediums configured to store instructions that when executed cause or direct an agricultural vehicle to perform operations, the operations comprising:
communicatively interfacing with an agricultural implement coupled with the agricultural vehicle;
obtaining data generated based on the operation of an electric motor of the agricultural vehicle; and
directing the data to the agricultural implement.

17. One or more computer-readable mediums of claim 16, wherein the operations further comprise obtaining a request from the agricultural implement for the data, wherein the data is directed to the agricultural implement in response to the request.

18. One or more computer-readable mediums of claim 16, wherein the data is generated based on the operation of the electric motor includes one or more of: a torque, a rotational position, a rotational speed, a current, power, and a voltage.

19. One or more computer-readable mediums of claim 16, wherein the electric motor is configured to drive the implement or to drive at least one wheel of the vehicle.

20. One or more computer-readable mediums of claim 16, wherein the operations further comprise:
obtain second data from the coupled agricultural implement, the second data based on the performance of the agricultural function performed by the coupled agricultural implement; and
adjust an operation of the vehicle based on the second data.
